(19) United States
(12) Patent Application Publication
(10) Pub. No.: US 2016/0171110 A1
(43) Pub. Date: Jun. 16, 2016

(54) PERSONALIZED CONTENT BASED UPON USER PERCEPTION OF WEATHER

(71) Applicant: Yahoo, Inc., Sunnyvale, CA (US)

(72) Inventors: Shenglong Gao, San Francisco, CA (US); Greg Choi, Belmont, CA (US); Victor Yuguang Zhang, San Francisco, CA (US)

(21) Appl. No.: 14/572,036

(22) Filed: Dec. 16, 2014

(51) Int. Cl. G06F 17/30; H04L 29/08

(52) U.S. Cl. CPC G06F 17/30867; G06F 17/30554; G06F 17/3053; G06F 17/30598; G06F 17/30241; G06F 17/3087; H04L 67/306

(57) ABSTRACT

Different users may have different user perceptions of the weather. For example, a 70 year old Florida woman may feel frigid and be interested in crossword puzzles when the weather is below 60° and windy, whereas a 20 year old Ohio college student may feel active and have an interest in outdoor activities. Accordingly, content, targeted to a user's perception of a current weather condition (e.g., a mood of the user and/or an interest in engaging in an activity), may be provided to a user. In an example, a puzzle game app suggestion may be provided to the Florida woman. In another example, a trail running race advertisement may be provided to the college student.

### BACKGROUND

Users may obtain weather information from various sources, such as a weather app on a mobile device, a weather website, a social network, etc. The weather may affect how users feel and/or what activities users perform. In an example, a user may purchase a winter coat once the weather starts dipping into the 40s. In another example, a user may decide to forego leaving the house on a rainy day, and may instead stay inside and play videogames. Weather may affect different users in different ways. For example, a college student in Colorado may feel comfortable when the temperature is 55°, whereas an elderly woman who grew up in Florida, but resides in the same area, may feel frigid. Thus, different users may have different emotional reactions to weather. Without a better understanding of how a user's mood may be affected by the weather and/or other factors, general assumptions about what content and/or activities may be interesting to the user may be inaccurate (e.g., the college student may be interested in an outdoor activity whereas the elderly woman may be interested in baking, and thus a general recommendation for both the college student and the elderly woman may be inaccurate). Unfortunately, many computing devices and/or content providers may lack technology that can determine a user's interests based upon the weather, and thus a user may expend considerable computing resources, such as network bandwidth, battery life of a mobile device, etc., attempting to locate content that may suit the user's mood.

### SUMMARY

In accordance with the present disclosure, one or more systems and/or methods for identification of user perception of weather and/or for providing personalized content based upon user perception of weather are provided. In an example of identifying user perception of weather, weather condition information associated with a user may be accessed (e.g., 50° and windy on a Tuesday in December). User contextual information, of the user during a timespan corresponding to the weather condition information, may be accessed (e.g., an email receipt and social network post may indicate that the user bought an ice cream cone on Tuesday). The user contextual information may be evaluated to determine a potential user perception of the weather condition information (e.g., the user may have felt comfortable at 50° with wind). In an example, a confidence metric may be determined for the potential user perception (e.g., a 15% confidence that the user feels comfortable at 50° with wind). In an example, user perceptions of other users that are similar to the user may be used to increase, decrease, or maintain the confidence metric (e.g., the 15% confidence may be increased to a 19% confidence based upon a second user, similar in age and location with the user, buying a slice of ice cream cake when the weather is 50° and windy). A user profile may be generated for the user based upon the potential user perception of the weather condition information.

In an example of providing personalized content based upon user perception of weather, current weather condition information, of a current weather condition associated with a location of a user, may be accessed (e.g., 69° with a high UV index). A user profile of the user may be evaluated utilizing the current weather condition information (e.g., a profile database, comprising the user profile, may be queried using the current weather condition information to identify an entry correlating the weather condition to a user perception) to determine the user perception of the current weather condition (e.g., the user profile may indicate that the user feels uncomfortably hot over 67° and is sensitive to the sun). Content (e.g., a sunscreen lotion advertisement; a recommendation to wear a hat; a homepage where indoor activities, sunscreen lotion, and sun umbrellas are ordered before other sun-based content, etc.), corresponding to the user perception may be identified and accessed. In this way, content, that is relevant and/or interesting to the user, may be provided to the user.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of identification of user perception of weather.

FIG. 5 is a component block diagram illustrating an example system for identification of user perception of weather, where one or more user profiles are generated.

FIG. 6 is a component block diagram illustrating an example system for identification of user perception of weather, where similar users are clustered for user perception identification and propagation.

FIG. 7 is a flow chart illustrating an example method of providing personalized content based upon user perception of weather.

FIG. 8A is a component block diagram illustrating an example system for providing personalized content based upon user perception of weather, where content is provided to a user (A).

FIG. 8B is a component block diagram illustrating an example system for providing personalized content based upon user perception of weather, where content is provided to a user (B).

FIG. 8C is a component block diagram illustrating an example system for providing personalized content based upon user perception of weather, where content is provided to a user (C).

FIG. 9 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. COMPUTING SCENARIO

The following provides a discussion of some types of computing scenarios in which the disclosed subject matter may be utilized and/or implemented.

1.1. Networking

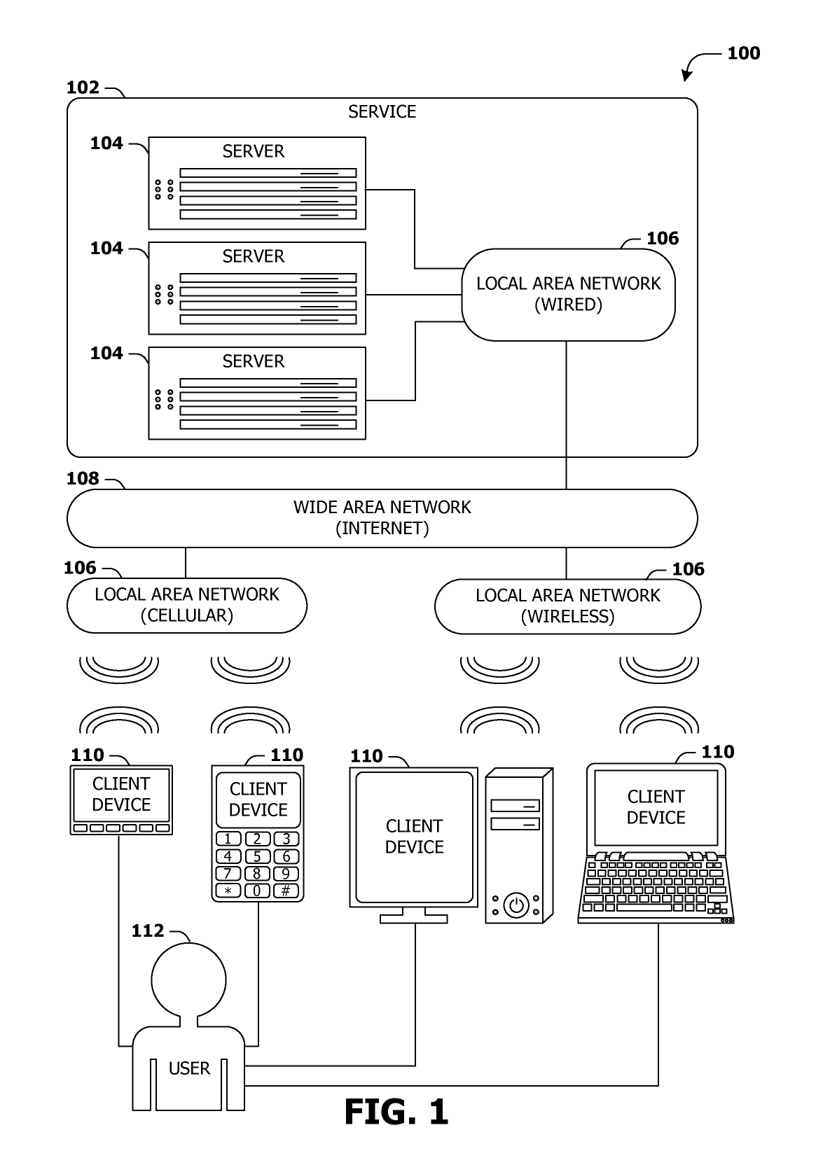

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

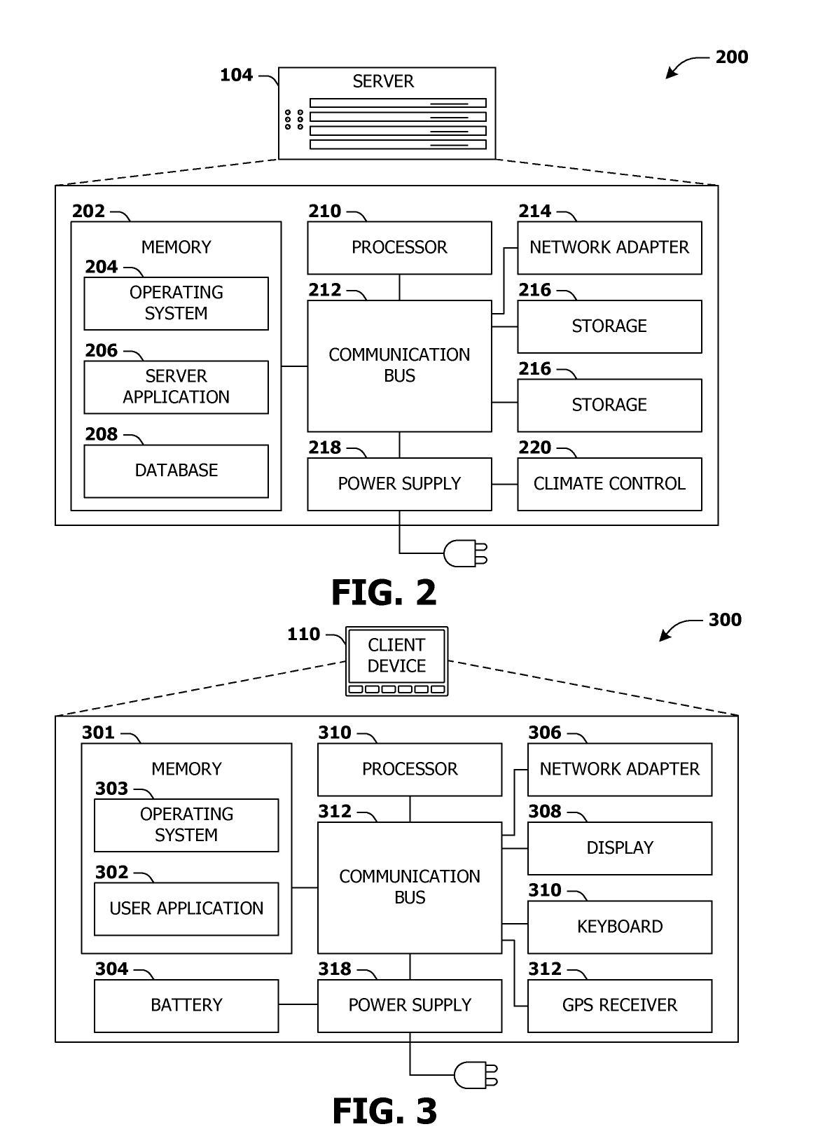

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. PRESENTED TECHNIQUES

One or more systems and/or techniques for identification of user perception of weather and/or for providing personalized content based upon user perception of weather are provided. Many computing devices and/or environments may lack computing resources, detection techniques, and/or functionality to determine what content, such as advertisements, recommendations, and/or other information (e.g., a video, text, an activity suggestion, an app to download, etc.) may be interesting to a user (e.g., the user be in the mood for enjoying a bike ride). As provided herein, weather condition information of a current weather condition (e.g., precipitation, temperature, humidity, wind, UV index, pollution, etc.) may be leveraged to determine a user perception, such as a current mood and/or interest in doing an activity, of the user. The user perception may be tailored to the user based upon age, location, gender, culture, user specified information (e.g., the user may create a social network post “this rain just bums me out”), user activities (e.g., the user may purchase a scarf when the weather dips below 45°), and/or other information specified through a user profile of the user. Content, associated with the user perception (e.g., the user may be in an energetic mood based upon a current weather condition of 85° and sunny), may be identified, accessed, and provided to the user (e.g., a bike rental recommendation for a bike rental reservation website may be provided to the user).

The ability to provide users with relevant content may reduce network bandwidth, time, and/or computing resources otherwise utilized by users in an attempt to locate such content on their own (e.g., manually searching websites for activities to do or losing interest in a weather app because wind, humidity, and a raw temperature value may not provide an accurate indicator as to how the user may feel based upon the weather or what the user may want to do). Many content providers may not have information, processing resources, and/or network bandwidth to leverage weather information and user contextual information to determine a user perception of a current weather condition that may be indicative of a mood of the user to engage in a particular activity.

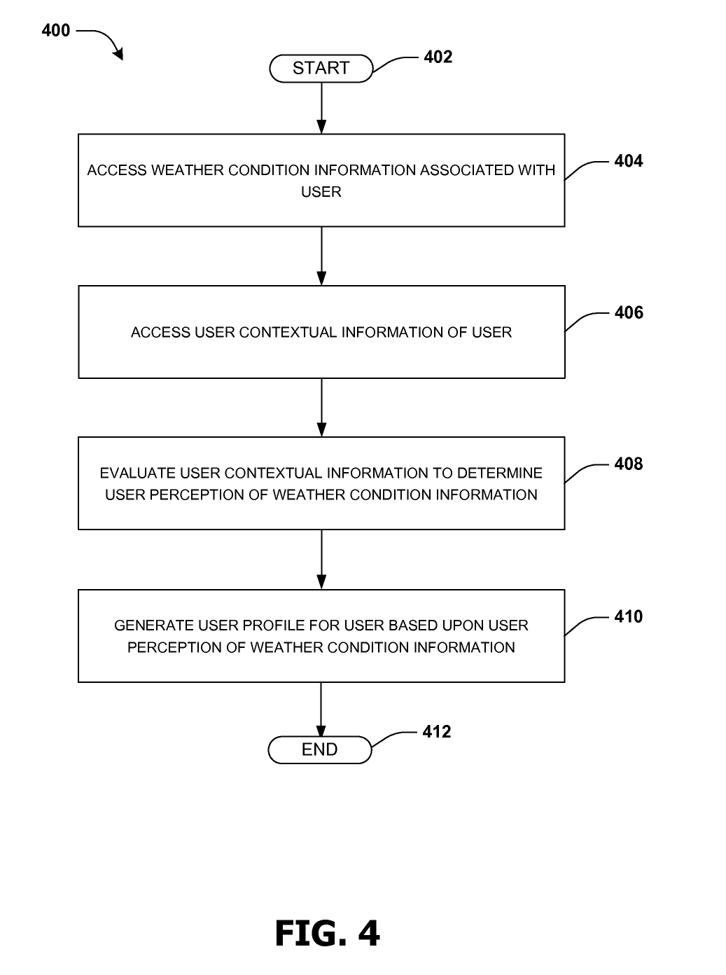

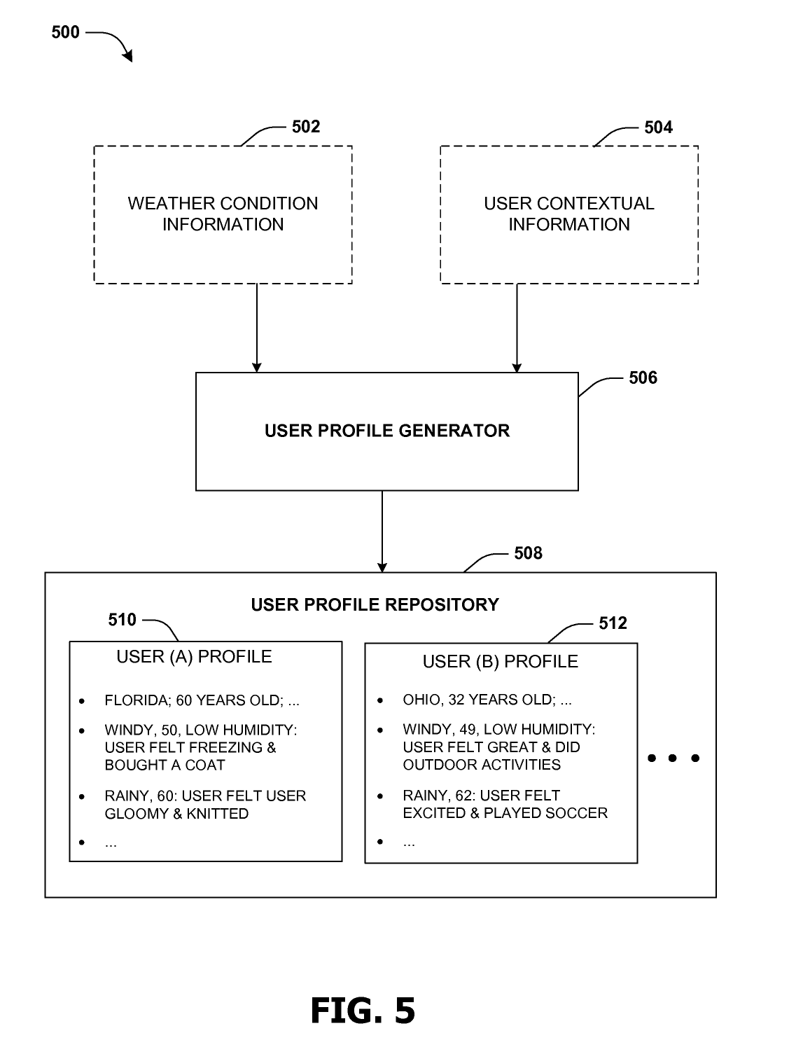

An embodiment of identification of user perception of weather is illustrated by an example method 400 of FIG. 4. At 402, the method starts. At 404, weather condition information, associated with a user, may be accessed. For example, a mobile device of the user may indicate that the user was in Ohio on Wednesday while the weather was humid and 76°. At 406, user contextual information, of the user during a timespan corresponding to the weather condition information, may be accessed. For example, the user may create a social network post “it is too hot outside, I might play videogames and stay in” and a videogame console may provide an indication that the user played 6 hours of videogames. The user contextual information may comprise a social network post, a microblog message, a consumer good purchase (e.g., a videogame rental), an application accessed by the user (e.g., an indoor activity suggestion app), a number of weather check events performed by the user (e.g., the more the user checks the weather the more the weather may affect the user's mood), message communication by the user, or an activity of the user derived from at least one of locational information (e.g., the user being in a living room for 6 hours), motion sensor information, audio sensor information, or visual sensor information of the user (e.g., a wearable device, such as a smartwatch or smart glasses, may determine that the user is interacting with a television for 6 hours). The user may take affirmative action, such as providing opt-in consent, to allow access to and/or use of user contextual information (e.g., social network posts, microblogs, videogame console usage, etc.), such as for the purpose of evaluating user contextual information to determine potential user perceptions of weather condition information, such as how the weather affects the user's mood (e.g., where the user responds to a prompt regarding the collection and/or use of such information).

At 408, the user contextual information may be evaluated to determine a user perception of the weather condition information. For example, this particular user may be in an indoor activity mood (e.g., a gloomy mood, a gaming mood, a low key mood, a bored mood, an uncomfortable mood, etc.) based upon the weather being humid and 76° or above. In an example, a confidence metric may be determined for the user perception (e.g., a 21% confidence metric based upon the social network post and the 6 hours of videogame playtime). In an example, other users, such as a second user, that are similar to the user above a user similarity threshold (e.g., similar in age, gender, location, career, culture, hobbies, etc.), may be identified. Responsive to the user perception of the weather condition information (e.g., the indoor activity mood when the weather is humid and 76° or above) corresponding to the second user, the confidence metric may be increased (e.g., increased to 25%). At 410, a user profile may be generated based upon the user perception of the weather condition information (e.g., the user profile may indicate that there is a 25% confidence that the user may be in an indoor activity mood, such as a mood to play videogames, when the weather is humid and 76° or above). It may be appreciated that different user profiles may be created and/or updated for different users because users may have different perceptions for the same weather conditions due to personal preferences of such users.

In an example, machine learning may be utilized to determine user perceptions of users regarding various weather condition information. For example, a plurality of users may be clustered based upon user identifying information of the plurality of user. Users may be clustered based upon age, such as clustering grade-schoolers into a first cluster and elderly people into a second cluster because the grade-schoolers may be more resilient to cold than the elderly. Users may be clustered based upon gender and occupation, such as clustering business women in their 40s into a third cluster and 20 year old college students into a fourth cluster because a 40 year old business woman may prefer different clothing recommendations when feeling cold than a 20 year old college student. Location, culture, and/or a variety of user traits may be used to cluster similar users that may share similar user perceptions of weather conditions. For example, a first cluster may comprise a first set of users, such as the user, that are similar above a similarity threshold. Responsive to determining that the user has the user perception of the weather condition (e.g., the indoor activity mood when the weather is humid and 76° or above), the user perception may be assigned to users within the first set of users to create propagated user perceptions. Confidence metrics may be assigned to the propagated user perceptions. For example, a confidence metric for a second user may correspond to a similarity between the user and the second user (e.g., the more similar the users the higher the confidence that both users will have the indoor activity mood when the weather is humid and 76° or above). In this way, machine learning functionality may identify user perceptions, of users, for generating user profiles that may be used to identify content that may be relevant and/or interesting to a particular mood, which may be inferred from the weather, of a user. At 412, the method ends.

FIG. 5 illustrates an example of a system 500, comprising a user profile generator 506, for identification of user perception of weather. The user profile generator 506 may maintain a user profile repository 508 comprising user profiles used to determine user perceptions (e.g., a mood of a user; an activity with which the user may have an interest in engaging; a consumer good that may be interesting to the user; etc.) of weather conditions. For example, the user profile generator 506 may access weather condition information 502 (e.g., a windy 50° day with low humidity; a 60° rainy day; etc.) and user contextual information 504 of a user (A) (e.g., the user (A) lives in Florida and is 60 years old; the user (A) bought a coat because the user (A) may have felt freezing during the windy 50° day with low humidity; the user (A) stayed inside knitting because the user (A) may have felt gloomy during the 60° rainy day). The user profile generator 506 may generate a user (A) profile 510 based upon the weather condition information 502 and/or the user contextual information 504. In this way, the user profile generator 506 may generate user profiles for users, such as a user (B) profile 512 indicating that a user (B) is a 32 year old living in Ohio, felt great and did outdoor activities during a 49° windy day, and felt excited and played soccer during a 62° rainy day), because different users such as user (A) and user (B) may react differently to weather (e.g., the user (A) may feel gloomy and/or freezing when the weather is rainy, windy, and below 60° and thus may prefer indoor activities, whereas user (B) may feel excited and do outdoor activities on such days). In an example, user profiles may be stored within a data structure, such as one or more tables of a database, that may be queried using current weather condition information to identify an entry correlating the current weather condition information to a user perception.

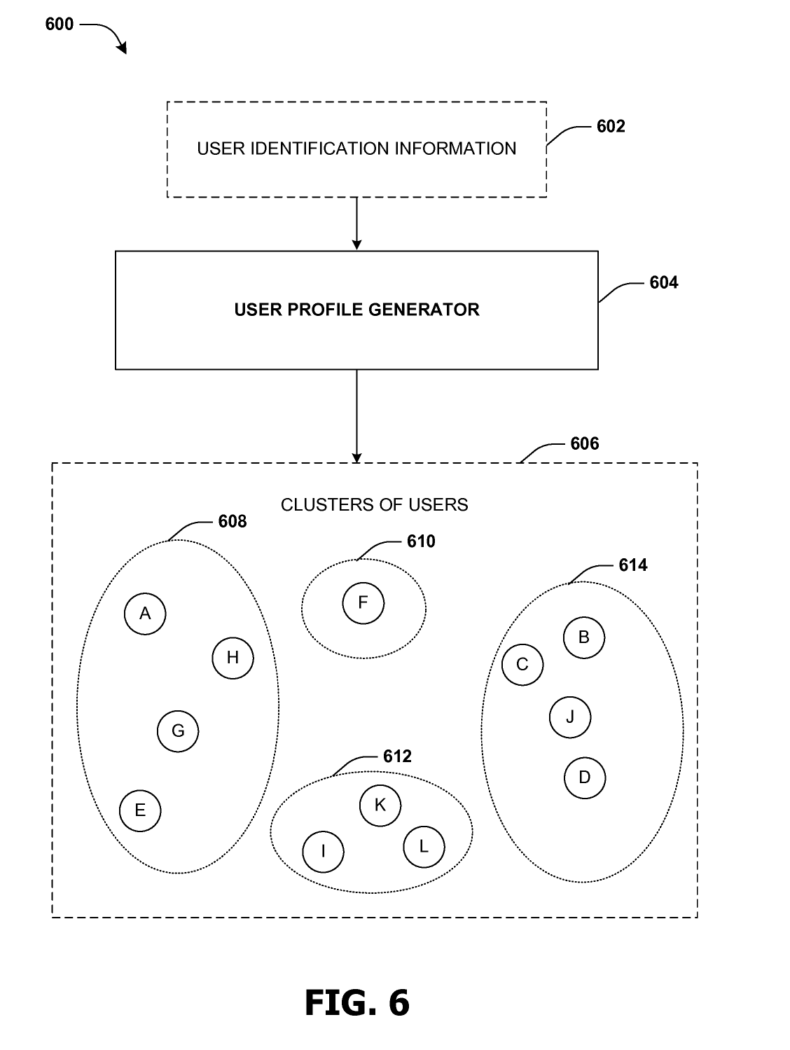

FIG. 6 illustrates an example of a system 600, comprising a user profile generator 604, for identification of user perception of weather. The user profile generator 604 may be configured to cluster users into clusters of users 606 based upon user identification information 602. For example, a first cluster 608 may comprise a user (A), a user (E), a user (G), a user (H), and/or other users that are similar above a similarity threshold, such as where the users may be in their 20s living in Chicago. A second cluster 610 may comprise a user (F) where user (F) has a rare skin disorder and cannot be in direct sunlight. A third cluster 612 may comprise user (I), user (K), user (L), and/or other users that are similar above the similarity threshold, such as where the users may be professional football players living in Florida. A fourth cluster 614 may comprise user (B), user (C), user (D), user (J), and/or other users that are similar above the similarity threshold, such as where the users may be California surfer culture teenagers. In this way, users that may have similar emotional reactions (e.g., tendencies to purchase similar products, do similar activities, listen to similar music, etc.) to various weather conditions may be grouped together for generating of user profiles indicating how users may perceive weather. In an example, if user (A) feels warm and does outdoor activities during windy days above 50 degree, then other users within the first cluster 608 may also have similar feelings. If user (D) feels cold and plays videogames during windy days around 50 degrees, then other users within the fourth cluster 614 may also have similar feelings. Because user perceptions of weather may be based upon ever changing user preferences (e.g., a user may initially enjoy playing in the snow at the start of Winter, but may have a tendency to prefer playing videogames on a new videogame console recently received as a gift), the clusters of users 606 may be updated as users fall into and/or out of different clusters depending on correlative strengths of user perceptions. In this way, user perceptions of users within a cluster may be propagated to other users within the cluster, such as by a machine learning algorithm.

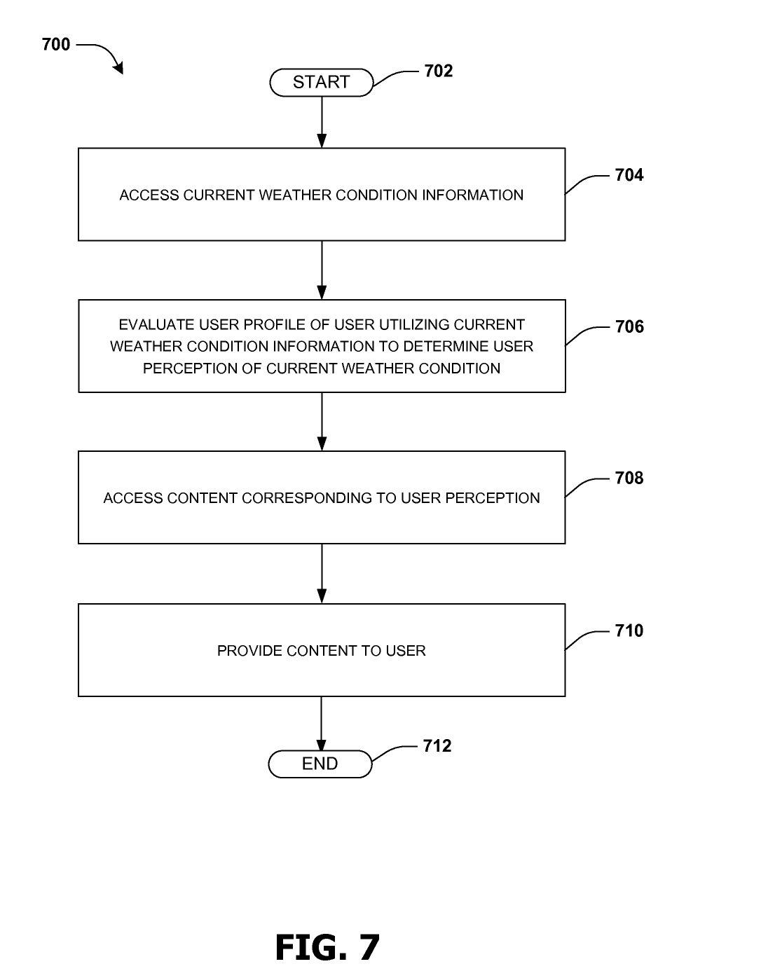

An embodiment of providing personalized content based upon user perception of weather is illustrated by an example method 700 of FIG. 7. At 702, the method starts. At 704, current weather condition information, of a current weather condition associated with a location of a user, may be accessed. The current weather condition information may comprise humidity, temperature, windy, precipitation, UV index, pollution, and/or other conditions (e.g., hail). For example, the user may be at home in California (e.g., a mobile device of the user may indicate that the user is in her California beach front property), and the current weather may be 59° and windy during a day in February. In an example, a user profile of the user may have been generated. The user profile may indicate how the user perceives various weather conditions, such as what mood the user may be in based upon a particular weather condition.

At 706, the user profile may be evaluated utilizing the current weather condition information (e.g., a profile database, comprising the user profile, may be queried using the current weather condition information to identify an entry correlating the weather condition to a user perception) to determine the user perception of the current weather condition. For example, the user profile may indicate that there is a 25% chance that the user may be in a skiing mood (e.g., the user may have previously engaged in winter sports when the weather dipped below 60° during February). At 708, content, corresponding to the user perception, may be accessed. The content may comprise a recommendation (e.g., “Try the new Coolest winter sport—Snow Soccer . . . ”), a media clip (e.g., a skiing resort promotional video), a website (e.g., a vacation website), an advertisement (e.g., a snowboard sale), an app suggestion (e.g., a sports app), and/or any other content that may be consumed by a user. Because multiple content from various content sources may correspond to the user perception, content candidates may be identified and prioritized. For example, a first content candidate (e.g., the skiing resort promotional video) may be prioritized over a second content candidate (e.g., a skiing movie suggestion) as the content based upon the first content candidate having a stronger correlation to the user perception than the second content candidate (e.g., the mood for participating in winter sports may correlate more to visiting a skiing resort than merely passively watching a skiing movie).

At 710, the content may be provided to the user. In an example, a recommendation of the content may be generated, and the recommendation may be sent to the user (e.g., a mobile alert comprising the text “Try the new Coolest winter sport—Snow Soccer . . . ”). In an example, a demand side platform may be invoked to identify an advertisement as the content based upon the advertisement corresponding to the user perception, and the advertisement may be provided to the user (e.g., displayed through an application interface, sent as an email, displayed through an advertisement interface on a webpage, etc.). In an example, the user perception may be provided to an advertising entity, and an advertisement may be received as the content from the advertising entity for display to the user. In an example, content may be arranged based upon the user perception, where content candidates with stronger correlations to the user perception may be displayed more prominently within a user interface than content candidates with weaker correlations to the user perception (e.g., a homepage may display winter sports activities in user interface elements having higher display prominence than summer sports activities).

In an example, user feedback may be received from the user. The user feedback may specify whether the user associated the user perception with the current weather condition information. In an example, the user may explicitly provide feedback that the user is not interested in winter sports activities when the weather dips below 60° and is windy. In an example, the user may implicitly provide feedback by ignoring the winter sports content and instead stays inside to read a surfing book.

Various users may perceive the current weather condition differently, and thus different content may be provided to different users for the same weather condition. For example, a determination may be made that the current weather condition information (e.g., 60° and windy) corresponds to a second location of a second user (e.g., a 70 year old man that lives in Florida and recently visited the doctor with a cold). A second user profile of the second user may be evaluated utilizing the current weather condition information to determine a second user perception of the current weather condition (e.g., the user may be in a gloomy mood, and thus may be interested in renting a movie and staying inside). Second content (e.g., a recommendation to download a movie rental app), but not the content (e.g., the skiing resort promotional video), corresponding to the second user perception may be accessed. The second content may be provided to the second user. At 712, the method ends.

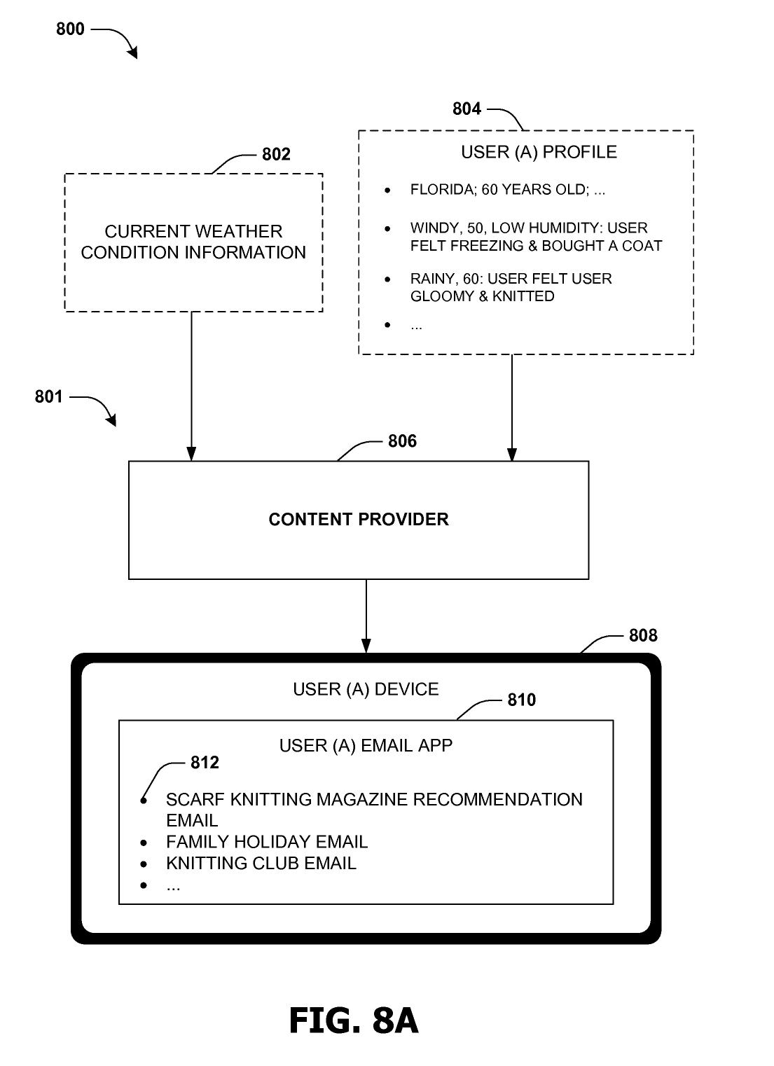

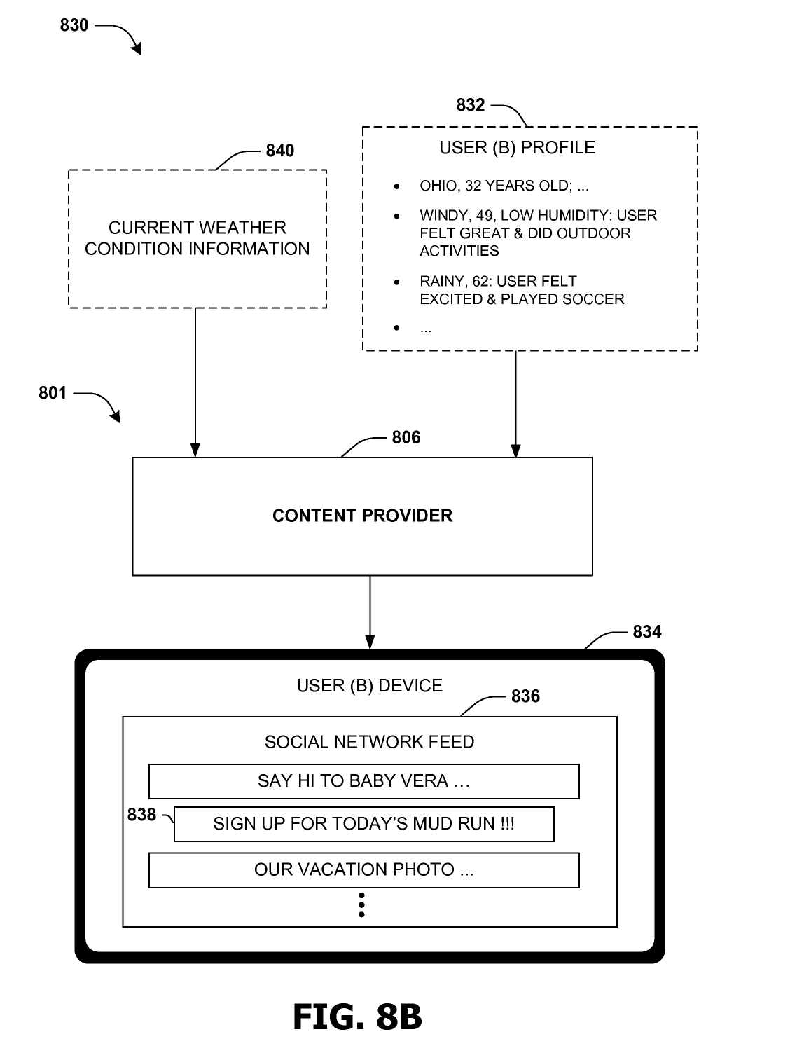

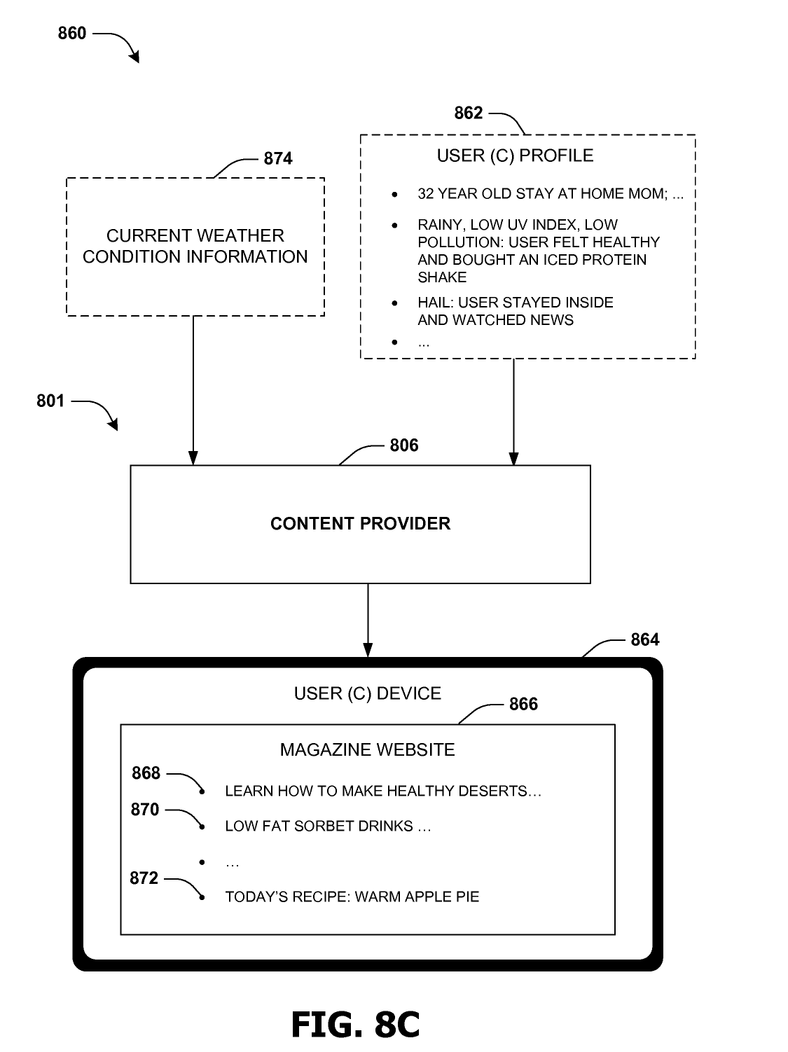

FIGS. 8A-8C illustrate examples of a system 801, comprising a content provider 806, for providing personalized content based upon user perception of weather. FIG. 8A illustrates an example 800 of the content provider 806 providing content for a user (A), such as a 60 year old lady living in Florida. For example, the content provider 806 may access current weather condition information 802 of a current weather condition associated with a location (A) of user (A), such as 58° and rainy. The content provider 806 may evaluate a user (A) profile 804 utilizing the current weather condition information 802 (e.g., a profile database, comprising the user (A) profile 804, may be queried using the current weather condition information 802 to identify an entry correlating the weather condition to a user perception) to determine a user perception of the current weather condition. For example, the user perception may indicate that the user (A) may feel gloomy and may have an interest in knitting because of the 58° and rainy weather condition. The content provider 806 may send a scarf knitting magazine recommendation 812 to an email account of the user (A), such that the user (A) may access the scarf knitting magazine recommendation 812 through a user (A) email app 810 hosted on a user (A) device 808.

FIG. 8B illustrates an example 830 of the content provider 806 providing second content for a user (B), such as a 32 year old college student living in Ohio. For example, the content provider 806 may access second current weather condition information 840 of a second current weather condition associated with a location (B) of user (B), such as 58° and rainy (e.g., the same weather condition that was experienced by the user (A) in Florida). The content provider 806 may evaluate a user (B) profile 832 utilizing the second current weather condition information 840 to determine a second user perception of the second current weather condition. For example, the second user perception may indicate that the user (B) may feel great and may be interested in engaging in outdoor sports activities because of the 58° and rainy weather condition. The content provider 806 may provide user (B) with a social network feed item 838 to sign up for today's mud run, such that the user (B) may access the social network feed item 838 through a social network feed 836 hosted on a user (B) device 834. Because user (B) may perceive the 58° and rainy weather condition differently than the user (A), the user (B) may be provided with different content than user (A).

FIG. 8C illustrates an example 860 of the content provider 806 providing third content for a user (C), such as a 32 year old stay at home mom. For example, the content provider 806 may access third current weather condition information 874 of a third current weather condition associated with a location (C) of user (C), such as 58° and rainy (e.g., the same weather condition that was experienced by the user (A) in Florida and user (B) in Ohio). The content provider 806 may evaluate a user (C) profile 862 utilizing the third current weather condition information 874 to determine a third user perception of the third current weather condition. For example, the third user perception may indicate that the user (C) felt healthy and may have an interest in healthy cooking activities because of the 58° and rainy weather condition. The content provider 806 may provide user (C) with a magazine website 866, accessible through a user (C) device 864, comprising content that is arranged based upon the user perception. For example, a “learn how to make healthy deserts” content item 868 and a “low fat sorbet drinks” content item 870 may be displayed more prominently than a “today's recipe: warm apple pie” content item 872 because the “learn how to make healthy deserts” content item 868 and the “low fat sorbet drinks” content item 870 may have a higher correlation to the interest in healthy cooking activities than the “today's recipe: warm apple pie” content item 872. Because user (C) may perceive the 58° and rainy weather condition differently than the user (A) and user (B), the user (C) may be provided with different content than user (A) and user (B).

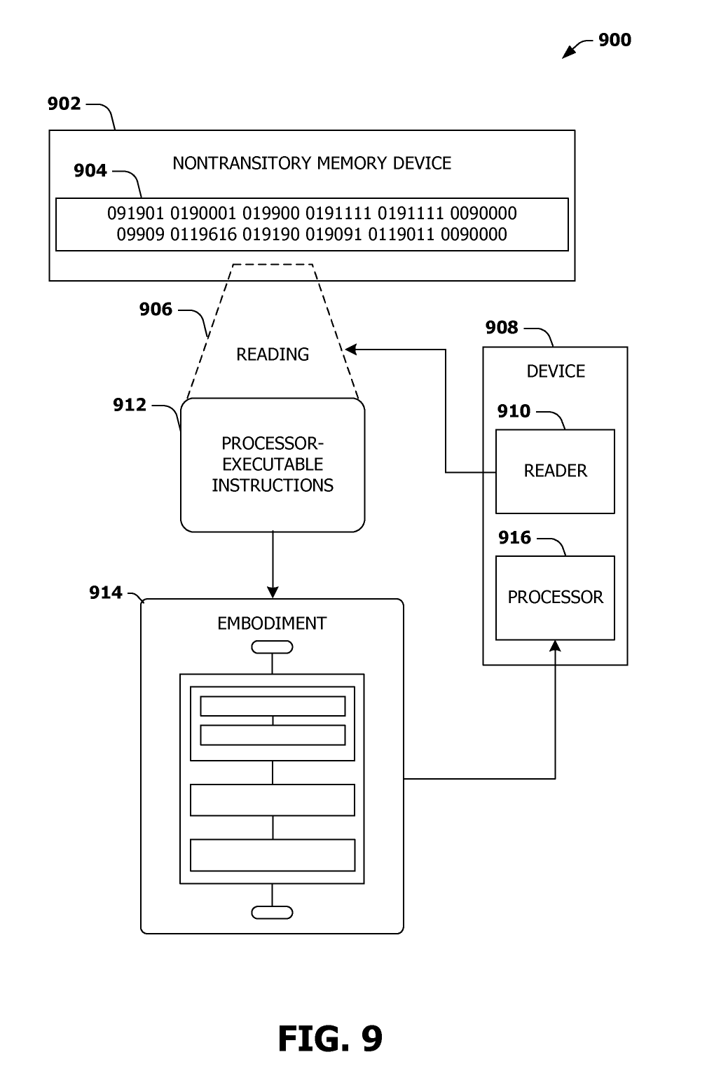

FIG. 9 is an illustration of a scenario 900 involving an example nontransitory memory device 902. The nontransitory memory device 902 may comprise instructions that when executed perform at least some of the provisions herein. The nontransitory memory device may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 902 stores computer-readable data 904 that, when subjected to reading 906 by a reader 910 of a device 908 (e.g., a read head of a hard disk drive, or a read operation invoked on a solid-state storage device), express processor-executable instructions 912. In some embodiments, the processor-executable instructions, when executed on a processor 916 of the device 908, are configured to perform a method, such as at least some of the example method 400 of FIG. 4 and/or at least some of the example 700 of FIG. 7, for example. In some embodiments, the processor-executable instructions, when executed on the processor 916 of the device 908, are configured to implement a system, such as at least some of the example system 500 of FIG. 5, at least some of the example system 600 of FIG. 6, and/or at least some of the example system 801 of FIGS. 8A-8C, for example.

### 3. USAGE OF TERMS

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for providing personalized content based upon user perception of weather, comprising:
accessing current weather condition information of a current weather condition associated with a location of a user;
evaluating a user profile of the user utilizing the current weather condition information to determine a user perception of the current weather condition;
accessing content corresponding to the user perception; and
providing the content to the user.

2. The method of claim 1, the accessing content comprising:
prioritizing a first content candidate over a second content candidate as the content based upon the first content candidate having a stronger correlation to the user perception than the second content candidate.

3. The method of claim 2, the providing the content comprising:
displaying the first content candidate within a first user interface element having a higher display prominence within a user interface than a second user interface element within which the second content candidate is displayed.

4. The method of claim 1, the providing the content comprising:
generating a recommendation based upon the content; and
sending the recommendation to the user.

5. The method of claim 1, the accessing content comprising:
invoking a demand side platform to identify an advertisement as the content based upon the advertisement corresponding to the user perception.

6. The method of claim 1, the accessing content comprising:
providing the user perception to an advertising entity; and
receiving an advertisement, as the content, from the advertising entity.

7. The method of claim 1, comprising:
accessing weather condition information associated with the user;
accessing user contextual information of the user during a timespan corresponding to the weather condition information;
evaluating the user contextual information to determine a potential user perception of the weather condition information; and
generating the user profile based upon the potential user perception of the weather condition information.

8. The method of claim 7, the evaluating the user contextual information comprising:
determining a confidence metric for the potential user perception.

9. The method of claim 8, the determining a confidence metric comprising:
identifying a second user having a similarity to the user above a user similarity threshold; and
responsive to determining that the potential user perception of the weather condition information is associated with the second user, increasing the confidence metric.

10. The method of claim 7, the user contextual information comprising at least one of a social network post, a microblog message, a consumer good purchase, a videogame played by the user, an application accessed by the user, a number of weather check events performed by the user, message communication by the user, or an activity of the user derived from at least one of locational information, motion sensor information, audio sensor information, or visual sensor information of the user.

11. The method of claim 1, comprising:
clustering a plurality of users based upon user identifying information of the plurality of users, a first cluster comprising a first set of users that are similar above a user similarity threshold, the first set of users comprising the user; and
responsive to determining that the user has the user perception of the current weather condition:
assigning the user perception to users within the first set of users to create propagated user perceptions; and
assigning confidence metrics to the propagated user perceptions, a confidence metric for a second user corresponding to a similarity between the user and the second user.

12. The method of claim 1, comprising:
receiving user feedback from the user, the user feedback specifying whether the user associates the user perception with the current weather condition information; and
adjusting the user profile based upon the user feedback.

13. The method of claim 1, comprising:
determining that the current weather condition information corresponds to a second location of a second user;
evaluating a second user profile of the second user utilizing the current weather condition information to determine a second user perception of the current weather condition, the second user perception different than the user perception;
accessing second content, but not the content, corresponding to the second user perception; and
providing the second content to the second user.

14. The method of claim 1, the user perception indicating a mood of the user.

15. A non-transitory computer readable medium comprising computer executable instructions that when executed by a processor perform a method for identification of user perception of weather, comprising:
accessing weather condition information associated with a user;
accessing user contextual information of the user during a timespan corresponding to the weather condition information;
evaluating the user contextual information to determine a user perception of the weather condition information; and
generating a user profile for the user based upon the user perception of the weather condition information.

16. The method of claim 15, comprising:
determining that a current weather condition, associated with a location of the user, corresponds to the weather condition information;
evaluating the user profile utilizing the current weather condition information to determine the user perception of the current weather condition;
accessing content corresponding to the user perception; and
providing the content to the user.

17. The method of claim 15, the providing the content comprising:
prioritizing a first content candidate over a second content candidate as the content based upon the first content candidate having a stronger correlation to the user perception than the second content candidate; and
displaying the first content candidate within a first user interface element having a higher display prominence within a user interface than a second user interface element within which the second content candidate is displayed.

18. The method of claim 15, the content corresponding to at least one of a recommendation or an advertisement.

19. A system for identification of user perception of weather, comprising:
a user profile generator configured to:
access weather condition information associated with a user;
access user contextual information of the user during a timespan corresponding to the weather condition information;
evaluate the user contextual information to determine a user perception of the weather condition information; and
generate a user profile for the user based upon the user perception of the weather condition information.

20. The system of claim 19, comprising:
a content provider configured to:
determine that a current weather condition, associated with a location of the user, corresponds to the weather condition information;
evaluate the user profile utilizing the current weather condition information to determine the user perception of the current weather condition;
access content corresponding to the user perception; and
provide the content to the user.
